(19) United States
(12) Patent Application Publication
(10) Pub. No.: US 2009/0193004 A1
(43) Pub. Date: Jul. 30, 2009

(54) APPARATUS AND METHOD FOR FORMING DATABASE TABLES FROM QUERIES

(75) Inventors: Richard Thomas Reynolds, JR., Pleasanton, CA (US); Philippe Meiniel, Maule (FR); Alexis-Jean Laurent Naibo, Levallois-Perret (FR)

Correspondence Address: SAP Global IP c/o Cooley Godward Kronish LLP;William S. Galliani, 777 6th Street NW, Suite 1100, Washington, DC, 20001, US

(73) Assignee: BUSINESS OBJECTS, S.A., Levallois-Perret (FR)

(21) Appl. No.: 12/022,970

(22) Filed: Jan. 30, 2008

(51) Int. Cl. G06F 17/30

(52) U.S. Cl. 707/4; 707/E17.014

(57) ABSTRACT

A computer readable storage medium includes executable instructions to capture data access commands from a query module utilizing a semantic layer. The data access commands are processed to produce table specification instructions and data access instructions to facilitate the construction and population of a table.

### FIELD OF THE INVENTION

This invention relates generally to the processing of digital data. More particularly, this invention relates to the formation of database tables from query information.

### BACKGROUND OF THE INVENTION

A semantic layer is a business representation of corporate data that helps end users access data using common business terms. The concept of a semantic layer is described in U.S. Pat. Nos. 5,555,403; 6,247,008; 6,578,027; and 7,181,435, the contents of which are incorporated herein by reference. Business Objects Americas, San Jose, Calif., the owner of the referenced patents and the assignee of the current invention, offers products that utilize a semantic layer, such as Web Intelligence™ and Desk Intelligence™.

A semantic layer maps complex data into familiar business terms such as product, customer, or revenue to offer a unified, consolidated view of data across the organization. By using common business terms, rather than programming language, to access, manipulate, and organize information, it is easier to access business data. These business terms are stored as objects in a universe, accessed through business views. Universes enable business users to access and analyze data stored in a relational database and OLAP cubes. This is a core business intelligence (BI) technology that frees users from technical minutia while ensuring correct results. In other words, the semantic layer insulates business users from underlying data complexity, while ensuring the business is accessing the correct data sources and using consistent terminology. Benefits of a semantic layer include improved end-user productivity and greater business autonomy from technical experts when accessing data. The accessed data is returned as a set of values. Semantic layers do not support the utilization of the returned set of values as a persistent data source. In other words, the returned set of values is typically scrutinized by the requesting user and is then overwritten. There is no easy way to load these values into a table of a database or a data warehouse for subsequent processing. Thus, query processing associated with a semantic layer is currently decoupled from the creation of tables in databases or data warehouses.

Extract, Transform and Load or ETL is a process that involves extracting data from data sources, transforming it to fit business needs, and loading it into a target system, such as a data warehouse or a database. ETL is commonly used for integration with legacy systems. Business Objects Americas, San Jose, Calif., offers an ETL product called Data Integrator™. ETL tools are utilized by technical experts that understand the structure of the source and target systems. Therefore, technically unsophisticated individuals are typically not in a position to form database tables using an ETL tool.

Thus, semantic layer products allow a technically unsophisticated user to create queries, but do not provide a way to easily allow the results of those queries to be persisted in tables of databases or data warehouses. Conversely, ETL tools provide techniques to form tables in databases or data warehouses, but they are not accessible to technically unsophisticated users.

Therefore, it would be desirable to provide techniques that allow a technically unsophisticated user to create tables for use in databases or data warehouses. Such techniques would allow technically unsophisticated users to summarize data into aggregate tables that are subsequently available for query processing.

### SUMMARY OF THE INVENTION

The invention includes a computer readable storage medium with executable instructions to capture data access commands from a query module utilizing a semantic layer. The data access commands are processed to produce table specification instructions and data access instructions to facilitate the construction and population of a table.

The invention also includes a computer readable storage medium with a query module utilizing a semantic layer to process a query and generate data access commands. A data access command processor processes the data access commands to produce table specification instructions and data access instructions. An Extract, Transform and Load (ETL) tool processes the table specification instructions to create a table and processes the data access instructions to populate the table.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

FIG. 3 illustrates a semantic layer Graphical User Interface (GUI) utilized in accordance with an embodiment of the invention to form a query.

FIG. 4 illustrates query results and table information that may be formed in accordance with an embodiment of the invention.

Like reference numerals refer to corresponding parts throughout the several views of the drawings.

### DETAILED DESCRIPTION OF THE INVENTION

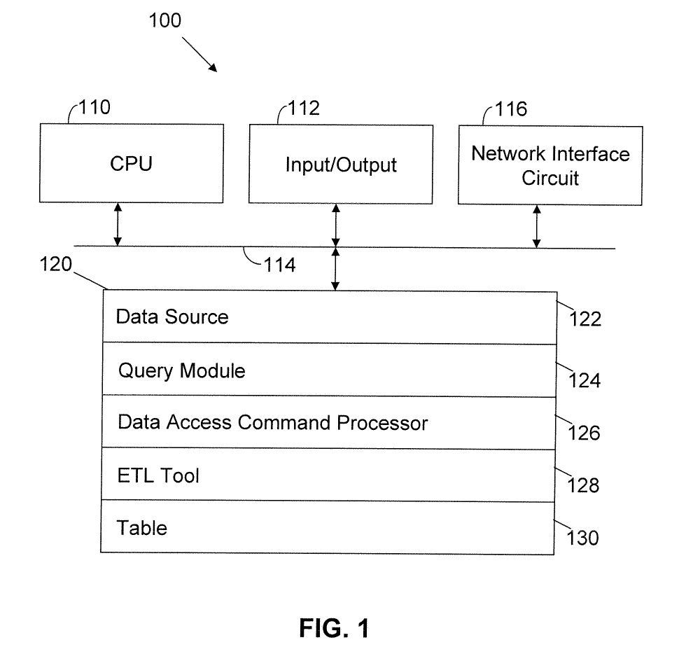

FIG. 1 illustrates a computer 100 configured in accordance with an embodiment of the invention. The computer 100 includes standard components, such as a central processing unit 110 connected to input/output devices 112 via a bus 112. The input/output devices 112 may include a keyboard, mouse, display, printer and the like. A network interface circuit 116 is also connected to the bus 114 to support connectivity to a network (not shown). Thus, the computer 100 may operate in a networked environment.

A memory 120 is also connected to the bus 114. The memory 120 stores a data source 122, which may be a relational database, transactional database, multi-dimensional (e.g., OLAP) data source or practically any other data source. A query module 124 is also stored in the memory 120. The query module 124 preferably utilizes a semantic layer to support the specification of queries using familiar words. For example, the query module 124 may be Web Intelligence™ or Desk Intelligence™ from Business Objects Americas, San Jose, Calif.

A data access command processor 126 is also stored in memory 120. The data access command processor 126 includes executable instructions to implement operations of the invention. In particular, the data access command processor 126 includes executable instructions to capture data access commands generated by the query module 124. For example, the query module 124 processes a query using familiar words and generates a set of data access commands (e.g., Structured Query Language (SQL) commands) to retrieve the data specified by the familiar words. The data access command processor 126 captures and processes the data access commands to produce table specification instructions. The table specification instructions are processed by the ETL tool 128 to generate a table 130. The data access command processor 126 also includes executable instructions to supply data access instructions. The data access instructions are used by the ETL tool 128 to populate the table 130. The table 130 may be a separate table or may be formed as part of the data source 122. Regardless of the embodiment, the query module 124 may be subsequently used to query the new table formed in accordance with the invention.

The modules of FIG. 1 are exemplary. The modules may be combined or further sub-divided. The modules are shown on a single computer for simplicity. Typically, the modules will be distributed across a network. For example, the data source 122 may be on one or more different computers and the ETL tool 128 may also be on a different computer. It is the operations of the invention that are significant, not the precise location or manner in which they are implemented.

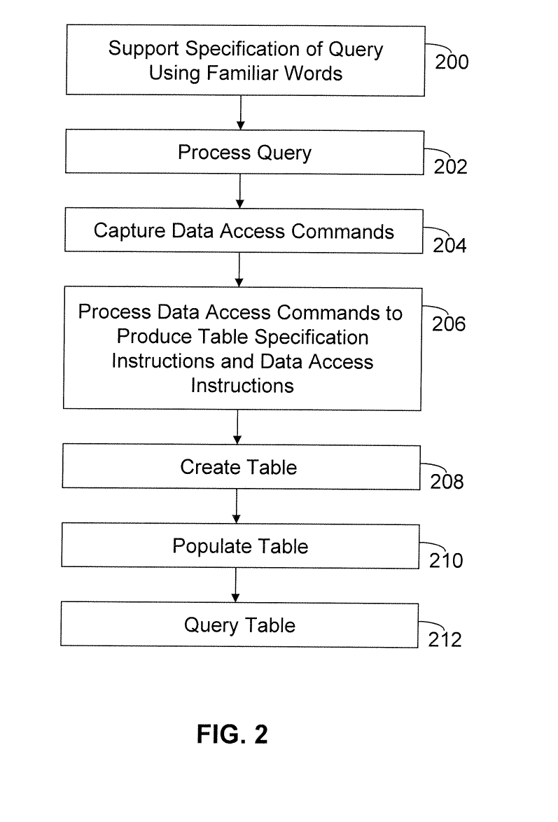

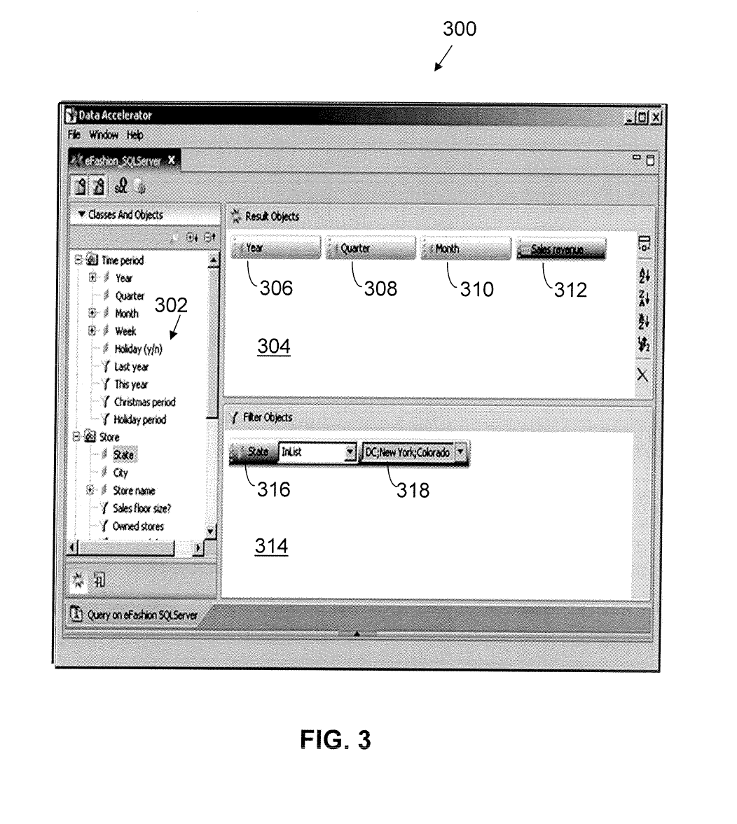

FIG. 2 illustrates processing operations associated with the modules stored in memory 120. The first operation of FIG. 2 is to support specification of a query using familiar words 200. The query module 124 may be used to implement this operation. FIG. 3 illustrates a Graphical User Interface (GUIT) 300 associated with a query module 124 that may be utilized in accordance with an embodiment of the invention.

The GUI 300 includes a data model object list 302, which is a list of familiar words that may be used by a technically unsophisticated user to construct a query to a data source. The familiar words form a part of a semantic layer. The GUI 300 also includes a result object panel 304. A user drags and drops objects from the object list 302 into the result panel 304 to form a query. In this example, a year object 306, a quarter object 308, a month object 310 and a sales revenue object 312 (a measure) are selected. The GUI 300 also includes a filter object panel 314 that allows the user to indicate the data model objects that need to meet specific requirements in order to select relevant data. In other words, the filter specifies restrictions on the values of data model objects. In this example, states are listed as a filter restriction in block 316. Block 318 lists a set of filter states, in this example, DC, New York and Colorado.

Returning to FIG. 2, the next processing operation is to process a query 202. For example, the query specified in the GUI 300 is processed. This operation is implemented with the query module 124 to produce a set of data access commands. For example, the following data access commands may be produced by a query module 124 processing the query specified in FIG. 3.

A. SELECT

B. Calendar_year_lookup.Yr as Year,

C. {fn concat(‘Q’, Calendar_year_lookup.Qtr)} as Quarter,

D. Calendar_year_lookup.Mth as Month,

E. Sum(Shop_facts.Amount_sold) as Sales_Revenue,

F. FROM

G. Calendar_year_lookup,

H. Shop_facts,

I. Outlet_Lookup

J. WHERE

K. (Outlet_Lookup.Shop_id=Shop_facts.Shop_id) AND (Shop_facts.Week_id=Calendar_year_lookup.Week_id) AND Outlet_lookup.State In (‘Colorado’, ‘DC’, ‘New York’)

L. GROUP BY

M. Calendar_year_lookup.Yr, {fn concat(‘Q’, Calendar_year_lookup.Qtr)}, Calendar_year_lookup.Mth

The SELECT clause of line A introduces the data model objects to be selected. Line B specifies the column expression for the year object 306, line C specifies the column expression for the quarter object 308, line D specifies the column expression for the month object 310 and line E specifies the sum computation associated with the sales revenue object 312.

The FROM clause of line F introduces the tables containing the columns required by the data model objects of the results panel 304 and filter panel 314. The calendar_year_lookup table of line G is required for selecting the Year, Quarter and Month data. The Shop_facts table of line H is required to determine sales revenue. The Outlet_Lookup table of line I is required for filtering by state.

The WHERE clause of line J introduces an expression that specifies how tables are joined and how data is filtered. The terms surrounding the first AND expression specify how the tables should be joined, which is determined by the schema of the database. The term after the second AND expression corresponds to the filter condition.

The GROUP BY clause of line K introduces the aggregate values of the SELECT clause. In order to calculate the sum of line E, the code must group on all other selected values of lines B-D. The sum is calculated for each group created by the GROUP BY clause.

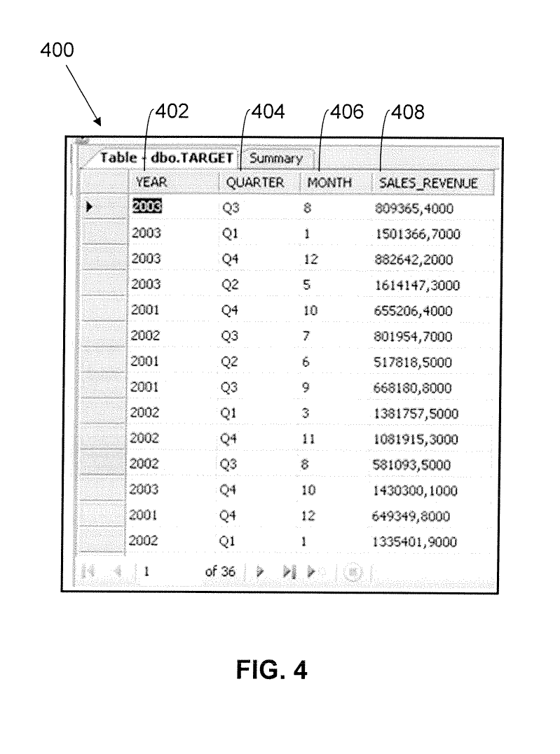

FIG. 4 illustrates the results produced by the processing of the query. In particular, FIG. 4 illustrates table 400 with columns year 402, quarter 404, month 406 and sales_revenue 408, respectively corresponding to year object 306, quarter object 308, month object 310 and sales_revenue object 312 of the query specified in FIG. 3.

Returning to FIG. 2, operations 200 and 202 have been fully disclosed. These operations represent typical operations utilized by a technically unsophisticated individual to secure a set of data values. The current invention exploits these well known operations to create and populate a table, which may then be queried. In particular, the next operation of FIG. 2 is to capture data access commands 204. For example, the data access command processor 126 includes executable instructions to secure from the query module 124 data access commands generated in response to a query. For example, the data access commands A-M above may be captured by the data access command processor 126. The data access command processor then processes the data access commands to produce table specification instructions and data access instructions 206. For example, the data access command processor may process the data access commands B-E to identify the year, quarter, month and sales_revenue columns required for a target table. These column names may be supplemented with a table name (specified by a user or a default name) to define a table. In particular, the data access command processor 126 may pass this information to an ETL tool 128, which automatically creates the table based upon the specified information. In an embodiment relying upon the Data Integrator™ tool from Business Objects Americas, San Jose, Calif., the information is converted into the Acta Translation Language (ATL™), which is used by Data Integrator™ to specify and construct a table.

After the table is created 208, it is populated 210. In particular, the ETL tool 128 utilizes data access instructions received from the data access command processor 126 to access data to populate the table. In general, the data access instructions correspond to the data access commands. However, the data access command processor 126 may modify the data access commands to form data access instructions tailored for a particular system. Once the table is formed and populated, it may be queried 212, for example, by using the query module 124.

Thus, the data access command processor 126 operates to capture data access commands associated with a query. The data access commands are then processed to produce table specification instructions used to define a table, such as by passing instructions to an ETL tool that defines the table. The data access commands are also processed to populate the created table. Again, the ETL tool may be used to fetch the data and populate the table.

While a query module with a semantic layer has traditionally allowed a technically unsophisticated user to secure ephemeral useful information, the current invention leverages this technology by utilizing the data access commands produced by such a query. Those data access commands form the basis for constructing and populating a table, which may then be used for further querying.

Those skilled in the art will appreciate that the techniques of the invention may be used to create aggregate tables. OLAP systems generally provide for multiple levels of detail within each dimension by arranging the members of each dimension into one or more hierarchies. A time dimension, for example, may be represented as a hierarchy starting with “Total Time”, and breaking down into multiple years, then quarters, then months. An Accounts dimension may start with “Profit”, which breaks down into “Sales” and “Expenses”, and so on. The number of aggregate values implied by a set of input data can be very large. For example, if Time and Profit dimensions are each six “generations” deep, then 36 (6×6) aggregate values are affected by a single data point. It follows that if all these aggregate values are to be stored, the amount of space required is proportional to the depth of all aggregating dimensions. For large databases this can cause the effective storage requirements to be many hundred times the size of the data being aggregated. Querying such a structure is computationally expensive. The present invention allows this information to be compressed into an aggregate table, which may then be queried quickly. That is, the invention allows a technically unsophisticated user to generate an aggregate table that may facilitate subsequent data query operations. Thus, the invention supports custom and rapid query processing for technically unsophisticated users. This is accomplished without adding additional computation power. In addition, this is accomplished by leveraging existing tools (e.g., a query processor) that is already familiar to a user. The invention improves the functionality associated with existing tools, such as a query processor and an ETL tool.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention,

1. A computer readable storage medium, comprising executable instructions to:
capture data access commands from a query module utilizing a semantic layer; and
process the data access commands to produce table specification instructions and data access instructions to facilitate the construction and population of a table.

2. The computer readable storage medium of claim 1 wherein the query module generates a Structured Query Language (SQL) expression defining data access commands.

3. The computer readable storage medium of claim 2 wherein the query module processes a query against the table.

4. The computer readable storage medium of claim 1 further comprising executable instructions to route the table specification instructions and data access instructions to an Extract, Transform and Load (ETL) tool.

5. The computer readable storage medium of claim 4 wherein the ETL tool constructs and populates the table.

6. The computer readable storage medium of claim 5 wherein the ETL tool constructs and populates an aggregate table.

7. A computer readable storage medium, comprising:
a query module utilizing a semantic layer to process a query and generate data access commands;
a data access command processor to process the data access commands to produce table specification instructions and data access instructions; and
an Extract, Transform and load (ETL) tool to process the table specification instructions to create a table and process the data access instructions to populate the table.

8. The computer readable storage medium of claim 7 wherein the query module generates a Structured Query Language (SQL) expression defining data access commands.

9. The computer readable storage medium of claim 7 wherein the query module processes a query against the table.
